(19) United States
(12) Patent Application Publication
(10) Pub. No.: US 2023/0235429 A1
(43) Pub. Date: Jul. 27, 2023

(54) HIGH MODULUS LIGHT ALLOY

(71) Applicant: Divergent Technologies, Inc., Los Angeles, CA (US)

(72) Inventors: Prabir Kanti CHAUDHURY, Los Angeles, CA (US); Michael Thomas KENWORTHY, Gardena, CA (US)

(21) Appl. No.: 17/584,221

(22) Filed: Jan. 25, 2022

(51) Int. Cl. C22C 21/06; C22C 14/00; C22C 21/00; B33Y 70/00

(52) U.S. Cl. CPC C22C 21/06; C22C 14/00; C22C 21/00; B33Y 70/00

(57) ABSTRACT

Alloyed metals, and techniques for creating parts from alloyed metals, are disclosed. An apparatus in accordance with an aspect of the present disclosure comprises an alloy. Such an alloy comprises aluminum (Al), magnesium (Mg), and titanium (Ti), wherein a structure of the alloy has an elastic modulus of at least 68 gigapascals (GPa).

### BACKGROUND

### Field

The present disclosure relates generally to alloyed materials, and more specifically to 3-D printable alloys.

### Background

Three-dimensional (3-D) printing, also referred to as additive manufacturing (AM), presents new opportunities to more efficiently build structures, such as automobiles, aircraft, boats, motorcycles, busses, trains and the like. Applying AM processes to industries that produce these products has proven to produce structurally efficient transport structures. For example, an automobile produced using 3-D printed components can be made stronger, lighter, and consequently, more fuel efficient. Moreover, AM enables manufacturers to 3-D print parts that are much more complex and that are equipped with more advanced features and capabilities than parts made via traditional casting, forging, and machining techniques.

Despite these recent advances, a number of obstacles remain with respect to the practical implementation of AM techniques. For example, many existing alloys can be cast or molded to produce structures relatively free of defects, but when 3-D printed these alloys exhibit cracking and/or other defects. When components of a specified strength and/or ductility are desired in certain applications, manufacturers may be relegated to manufacturing the component using traditional casting, forging, and machining techniques because 3-D printing the components using existing alloys would result in components that are too weak or brittle.

### SUMMARY

Several aspects and features of 3-D printable metal alloys will be described more fully hereinafter with reference to 3-D printing techniques.

An apparatus in accordance with an aspect of the present disclosure comprises an alloy. An alloy, in accordance with an aspect of the present disclosure may comprise aluminum (Al), magnesium (Mg), and titanium (Ti), wherein the alloy has an elastic modulus of at least 68 gigapascals (GPa).

Such an alloy may further optionally include having a melting point of at least 195 degrees Celsius (° C.), being exposed to an operating temperature that is greater than 30 percent (%) of the melting point of the alloy, an amount of the Mg in the alloy being less than or equal to about 18 percent (%) by weight of the alloy, and an amount of the Ti in the alloy being less than or equal to about 15% by weight of the alloy.

Such an alloy may further optionally include at least one solute, the at least one solute being one or more of beryllium (Be), chromium (Cr), molybdenum (Mo), ruthenium (Ru), manganese (Mn), silicon (Si), cerium (Ce), yttrium (Y), and zirconium (Zr).

The at least one solute may include one or more of Be, Cr, Mo, Ru, and Mn, and an amount of the at least one solute in the alloy is less than or equal to about 50 percent (%) by weight of the alloy, the at least one solute may include Be in a proportion of less than or equal to about 12 percent (%) by weight of the alloy, and the at least one solute may further includes one or more of Si, Ce, and Zr in a total proportion of less than or equal to about 12 percent (%) by weight of the alloy.

The at least one solute may further include Be in a proportion of less than or equal to about 12 percent (%) by weight of the alloy, Cr in a proportion of between 10 and 25% by weight of the alloy, Mn in a proportion of less than or equal to about 15% by weight of the alloy, and one or more of Mo and Ru in a total proportion of less than or equal to about 20% by weight of the alloy.

The at least one solute may include Ce in a proportion of less than or equal to about 25 percent (%) by weight of the alloy, the at least one solute includes Ru in a proportion of less than or equal to about 40 percent (%) by weight of the alloy, and the at least one solute further includes one or more of Si, Ce, and Zr in a total proportion of less than or equal to about 15 percent (%) by weight of the alloy.

At least one solute may include one or more of Si, Ce, Y, and Zr, and an amount of the at least one solute is less than or equal to about 50 percent (%) by weight of the alloy.

The at least one solute may include Y in a proportion of less than or equal to 3 percent (%) by weight of the alloy, and the at least one solute further includes one or more of Si, Ce, and Zr in a total proportion of less than or equal to about 3 percent (%) by weight of the alloy.

An alloy in accordance with an aspect of the present disclosure may comprise titanium (Ti), magnesium (Mg), and aluminum (Al), wherein the alloy has an elastic modulus of at least 100 gigapascals (GPa).

Such an alloy may further optionally include the alloy having a melting point of at least 575 degrees Celsius (° C.), the alloy being exposed to an operating temperature that is greater than 30 percent (%) of the melting point of the alloy, an amount of the Mg in the alloy being less than or equal to 10% by weight of the alloy, and may further include at least one solute.

Such an alloy may further optionally include the at least one solute being one or more of beryllium (Be), chromium (Cr), molybdenum (Mo), ruthenium (Ru), manganese (Mn), silicon (Si), cerium (Ce), yttrium (Y), and zirconium (Zr).

The at least one solute may include Be in a proportion of less than or equal to about 5 percent (%) by weight of the alloy, and the at least one solute further includes one or more of Si, Ce, and Zr in a total proportion of less than or equal to about 5 percent (%) by weight of the alloy.

The at least one solute may include Be in a proportion of less than or equal to about 5 percent (%) by weight of the alloy, Cr in a proportion of between 20 and 50% by weight of the alloy, Mn in a proportion of between about 3 and 20% by weight of the alloy, and one or more of Mo and Ru in a total proportion of between about 3 and 20% by weight of the alloy.

The at least one solute may include Cr in a proportion of between about 20 and 50 percent (%) by weight of the alloy, Ru in a proportion of less than or equal to about 10% by weight of the alloy, and the at least one solute further includes one or more of Si, Ce, and Zr in a total proportion of less than or equal to about 5 percent (%) by weight of the alloy.

The at least one solute may include Y in a proportion of between about 20 and 50 percent (%) by weight of the alloy, and the at least one solute further includes one or more of Si, Ce, and Zr in a total proportion of between about 4 and 5% by weight of the alloy.

It will be understood that other aspects of printable alloys will become readily apparent to those skilled in the art from the following detailed description, wherein it is shown and described only several embodiments by way of illustration. As will be appreciated by those skilled in the art, the principles of the disclosure can be realized with other embodiments without departing from the scope of the present disclosure. Accordingly, the drawings and detailed description are to be regarded as illustrative in nature and not as restrictive.

### BRIEF DESCRIPTION OF THE DRAWINGS

Various aspects of the present disclosure will now be presented in the detailed description by way of example, and not by way of limitation, in the accompanying drawings, wherein:

FIGS. 1A-1D illustrate respective side views of a 3-D printer system in accordance with an aspect of the present disclosure;

FIG. 1E illustrates a functional block diagram of a 3-D printer system in accordance with an aspect of the present disclosure;

FIGS. 2A-2C illustrate alloy structures in accordance with an aspect of the present disclosure;

FIG. 3 illustrates a unit cell of a structure in accordance with an aspect of the present disclosure;

FIG. 4 shows a flow diagram illustrating an exemplary method for additively manufacturing a component in accordance with an aspect of the present disclosure;

FIG. 5 illustrates an assembly in accordance with an aspect of the present disclosure;

FIG. 6 illustrates a cross-sectional view of an assembly in accordance with an aspect of the present disclosure; and

FIG. 7 illustrates a joint feature of an assembly in accordance with an aspect of the present disclosure.

### DETAILED DESCRIPTION

The detailed description set forth below in connection with the drawings is intended to provide a description of exemplary embodiments of 3-D printable alloys, and it is not intended to represent the only embodiments in which the disclosure may be practiced. The term “exemplary” used throughout this disclosure means “serving as an example, instance, or illustration,” and should not necessarily be construed as preferred or advantageous. The detailed description includes specific details for the purpose of providing a thorough and complete disclosure that fully conveys the scope of the disclosure to those skilled in the art. However, the disclosure may be practiced without these specific details. In some instances, well-known structures and components may be shown in block diagram form, or omitted entirely, in order to avoid obscuring the various concepts presented throughout this disclosure.

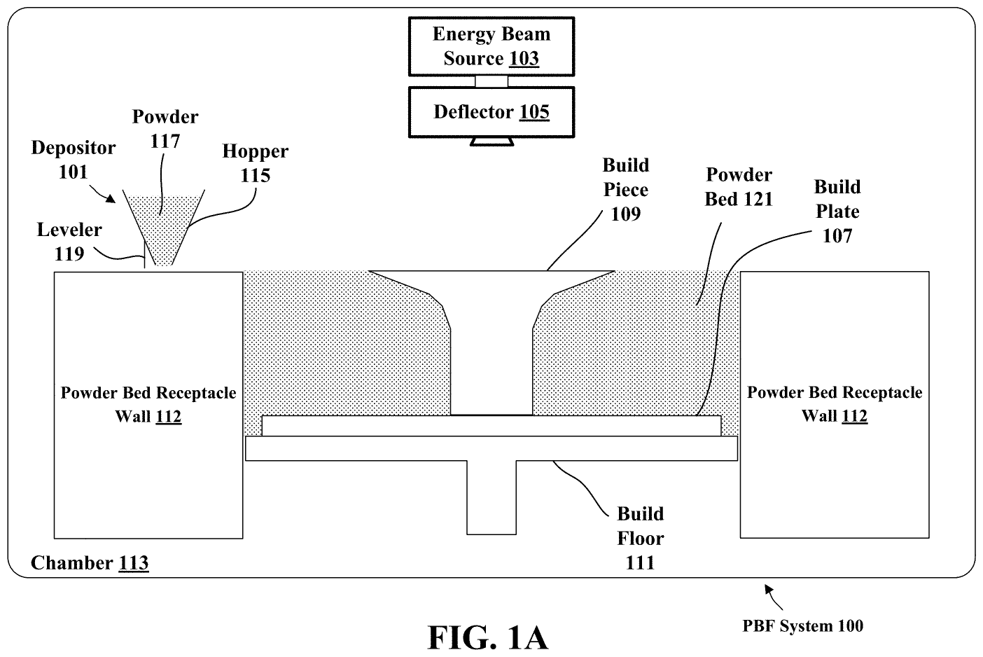

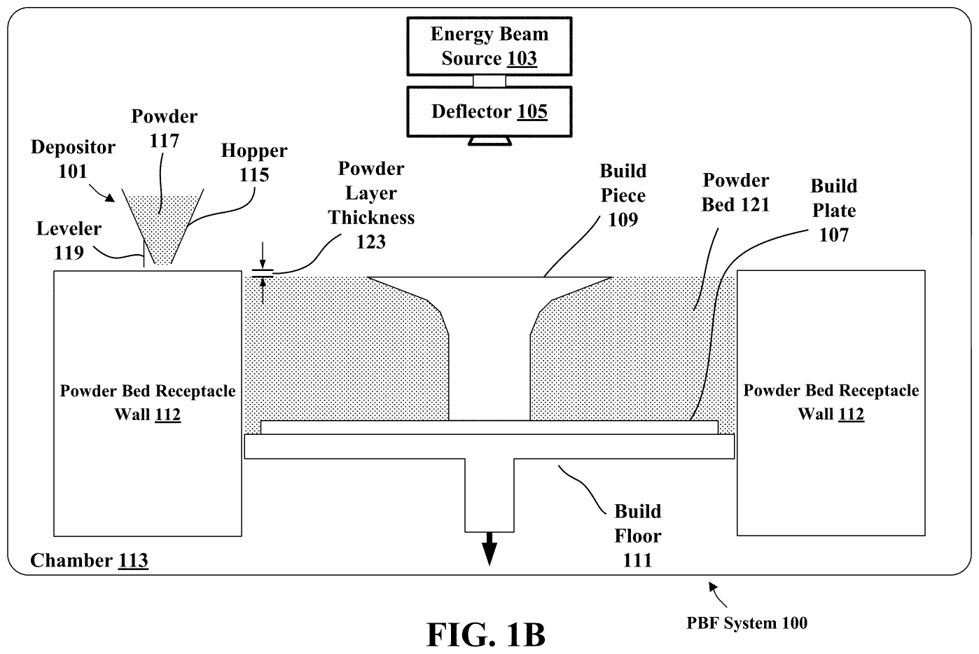

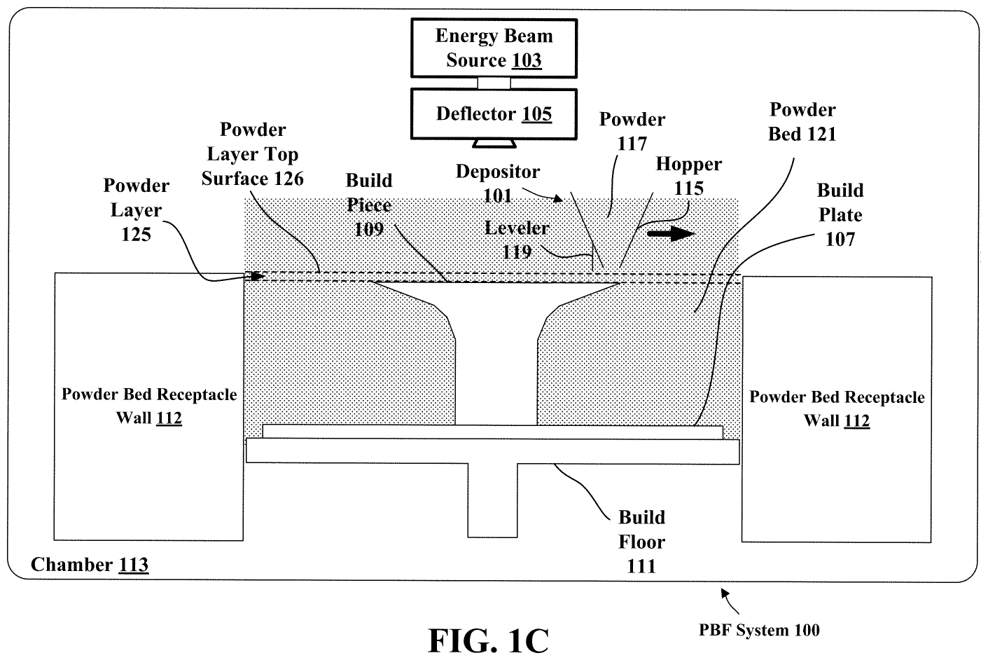

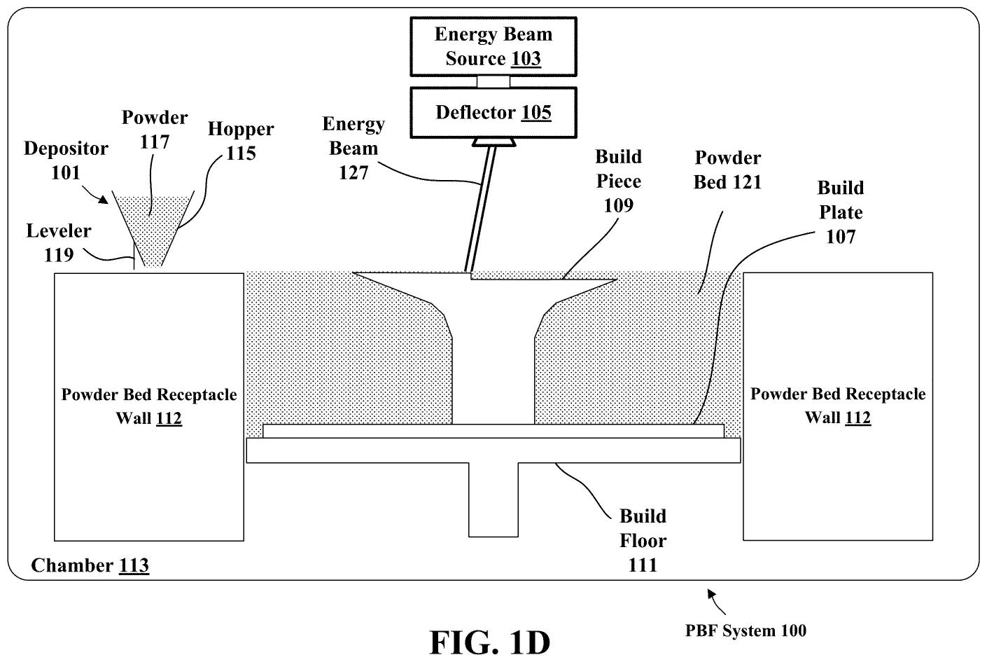

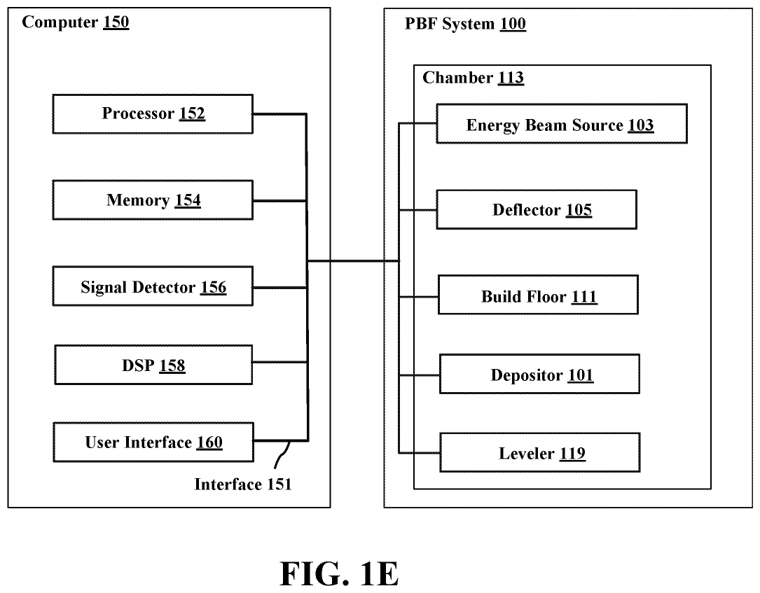

FIGS. 1A-D illustrate respective side views of an exemplary 3-D printer system.

In this example, the 3-D printer system is a powder-bed fusion (PBF) system 100. FIGS. 1A-D show PBF system 100 during different stages of operation. The particular embodiment illustrated in FIGS. 1A-D is one of many suitable examples of a PBF system employing principles of this disclosure. It should also be noted that elements of FIGS. 1A-D and the other figures in this disclosure are not necessarily drawn to scale, but may be drawn larger or smaller for the purpose of better illustration of concepts described herein. PBF system 100 can include a depositor 101 that can deposit each layer of metal powder, an energy beam source 103 that can generate an energy beam, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 can also include a build floor 111 positioned within a powder bed receptacle. The walls of the powder bed receptacle 112 generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed above with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109. In various exemplary embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 can include an optical system that uses reflection and/or refraction to manipulate the laser beam to scan selected areas to be fused.

In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

FIG. 1E illustrates a functional block diagram of a 3-D printer system in accordance with an aspect of the present disclosure. In an aspect of the present disclosure, control devices and/or elements, including computer software, may be coupled to PBF system 100 to control one or more components within PBF system 100. Such a device may be a computer 150, which may include one or more components that may assist in the control of PBF system 100. Computer 150 may communicate with a PBF system 100, and/or other AM systems, via one or more interfaces 151. The computer 150 and/or interface 151 are examples of devices that may be configured to implement the various methods described herein, that may assist in controlling PBF system 100 and/or other AM systems.

In an aspect of the present disclosure, computer 150 may comprise at least one processor 152, memory 154, signal detector 156, a digital signal processor (DSP) 158, and one or more user interfaces 160. Computer 150 may include additional components without departing from the scope of the present disclosure.

Processor 152 may assist in the control and/or operation of PBF system 100. The processor 152 may also be referred to as a central processing unit (CPU). Memory 154, which may include both read-only memory (ROM) and random access memory (RAM), may provide instructions and/or data to the processor 152. A portion of the memory 154 may also include non-volatile random access memory (NVRAM). The processor 152 typically performs logical and arithmetic operations based on program instructions stored within the memory 154. The instructions in the memory 154 may be executable (by the processor 152, for example) to implement the methods described herein.

The processor 152 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

Signal detector 156 may be used to detect and quantify any level of signals received by the computer 150 for use by the processor 152 and/or other components of the computer 150. The signal detector 156 may detect such signals as energy beam source 103 power, deflector 105 position, build floor 111 height, amount of powder 117 remaining in depositor 101, leveler 119 position, and other signals. DSP 158 may be used in processing signals received by the computer 150. The DSP 158 may be configured to generate instructions and/or packets of instructions for transmission to PBF system 100.

The user interface 160 may comprise a keypad, a pointing device, and/or a display. The user interface 160 may include any element or component that conveys information to a user of the computer 150 and/or receives input from the user.

The various components of the computer 150 may be coupled together by interface 151, which may include, e.g., a bus system. The interface 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, one or more of the components may be combined or commonly implemented. For example, the processor 152 may be used to implement not only the functionality described above with respect to the processor 152, but also to implement the functionality described above with respect to the signal detector 156, the DSP 158, and/or the user interface 160. Further, each of the components illustrated in FIG. 1E may be implemented using a plurality of separate elements.

Alloy Compositions

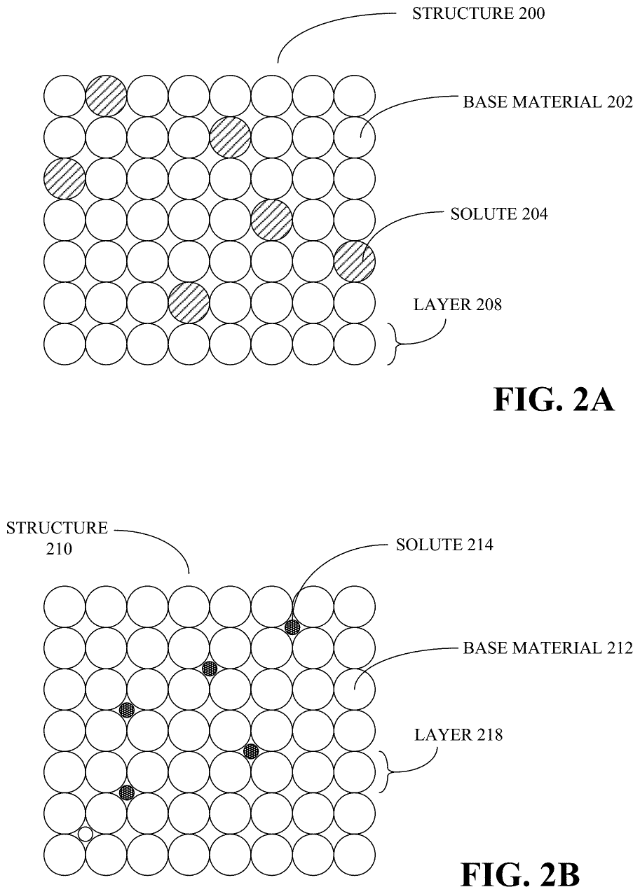

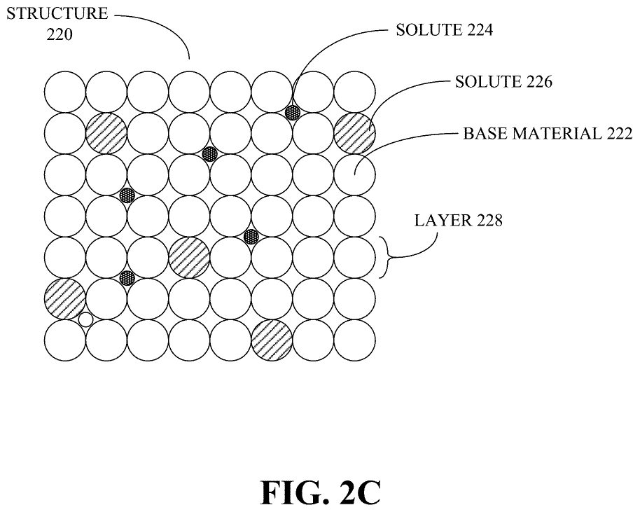

FIGS. 2A and 2B illustrate alloy structures in accordance with an aspect of the present disclosure.

FIG. 2A illustrates an alloy structure 200 with base material atoms and solute 204 atoms included in alloy structure 200. In an aspect of the present disclosure, alloy structure 200 may have an underlying structure of the base material, which may be, for example, a crystalline-type or periodic structure, such as a cubic structure, i.e., where an atom of the base material is located at each corner of a cube, a face-centered cubic structure, i.e., where an atom of the base material is located at the corners and in at least one face of a cube, etc. For example, as a base material, aluminum (Al) metal arranges in a face-centered cubic (fcc) structure, titanium arranges in a body-centered cubic (bcc) structure or a hexagonal close packed (hcp) structure, etc. As shown in FIG. 2A, atoms of base material 202 can be arranged in layers, such as a base material layer 208, which may include one or more atoms of substitutional solute 204.

In FIG. 2A, the base material structure of alloy structure 200 is shown as a cubic structure, however, the principles described with respect to alloy structure 200 may be applied to any base material structural arrangement without departing from the scope of the present disclosure. In FIG. 2A, at some locations within alloy structure 200, base material 202 has been replaced by solute 204. With a replacement approach, an alloy may be referred to as a “substitutional alloy,” because the solute 204 is substituting for the base material 202 within the base material structure of alloy structure 200. In an aspect of the present disclosure, solute 204 may be one or more different atoms and/or compounds that act as substitutional replacements for base material 202. For example, and not by way of limitation, base material 202 may be iron (Fe), and solute 204 may be one or more of nickel (Ni), chromium (Cr), and/or tin (Sn). Substitutional alloys may be formed when the solute 204 is of approximately the same atomic size as base material 202.

In FIG. 2B, an alloy structure 210 includes a base material 212 within a cubic structure like the base material structure shown in FIG. 2A. Like FIG. 2A, the principles described with respect to alloy structure 210 may be applied to any base material structural arrangement without departing from the scope of the present disclosure. Alloy structure 210 also includes a solute 214. Solute 214 is included in alloy structure 210 at locations other than the locations of base material 212, i.e., at interstitial locations within base material structure of alloy structure 210. In such an aspect of the present disclosure, an alloy with such an addition to base material 212 may be referred to as a “interstitial alloy,” because the solute 214 is being made part of the structure at interstitial locations within the base material structure of alloy structure 210. In such an aspect, solute 214 may be one or more different atoms and/or compounds that act as interstitial insertions into the base material structure of alloy structure 210. For example, and not by way of limitation, base material 212 may be aluminum (Al), and solute 214 may be one or more of magnesium (Mg), zirconium (Zr), and/or manganese (Mn). Interstitial alloys may be formed when solute 214 is of a smaller atomic size than base material 212. As shown in FIG. 2B, atoms of base material 212 can be arranged in layers, such as a base material layer 218, which may include one or more atoms of interstitial solute 214 interspersed between the layers.

FIG. 2C illustrates an example of a combination alloy, with an alloy structure 220 that can include a base material 222, an interstitial solute 224, and a substitutional solute 226. As shown in FIG. 2C, atoms of base material 222 can be arranged in layers, such as a base material layer 228, which may include one or more atoms of substitutional solute 206 and interspersed with one or more atoms of interstitial solute 224.

Aspects of the present disclosure can include substitutional alloys, interstitial alloys, and combination alloys with combinations of substitutional/interstitial solutes in a given alloy. Further, a base material (such as base material 202, 212, and 222) may include one or more elements, e.g., the base material may be a plurality of two materials, e.g., copper (Cu) and zinc (Zn), aluminum (Al) and titanium (Ti), etc., without departing from the scope of the present disclosure. Although the use of “base” in base material may mean that the base material is the majority of the composition of the alloy, such meaning is not necessarily always the case in many aspects of the present disclosure. In various embodiments, base material may indicate an underlying structure of the alloy, since different materials have different atomic arrangements, e.g., fcc, bcc, cubic, hcp, etc.

In an aspect of the present disclosure, solutes can be included with a base material to change one or more properties that the base material exhibits. For example, and not by way of limitation, carbon (C) may be added to Fe to increase strength and reduce oxidation. In other words, solutes may be added as impurities to a base material to change the characteristics of the bonds between atoms within a base material structure.

In many materials, and in many alloys, there are several basic characteristics that determine the suitability of that material/alloy for a given application. For example, and not by way of limitation, strength, heat resistance, and ductility are three characteristics that may be of interest in certain applications.

As shown in FIGS. 2A-C, a structure of an alloy, which may include base material(s) and solutes, can be classified in terms of its underlying atomic arrangements (e.g., fcc, bcc, hcp, etc.). Alloy structures can be made in a number of ways, but they are primarily fashioned by mixing together a base material with solutes (e.g., substitutional and/or interstitial) in various ratios and/or percentages. This may be done through smelting and/or melting the various components into a homogenous liquid and allowing the liquid to cool into a solid form.

The resultant alloy structure, whether interstitial, substitutional, polycrystalline, amorphous, or various combinations, provides different values for the properties of the alloy than the properties of the base material in a pure form. For example, alloying gold (Au) with silver (Ag) makes the resultant alloy harder, i.e., the resultant alloy of Au and Ag has a higher tensile strength than pure Au. Another reason that a pure base material structure may show reduced strength is that covalent and/or ionic bonding between atoms of the same element is limited. Since alloys contain a mixture of atom sizes, and a variety of valence electrons because some of the atoms in the alloy's structure can have slightly different sizes and/or different localized electrical properties, it is more difficult for layers in the base material arrangement, such as base material layers 208, 218, and 228, to shift with respect to one another, as the arrangement of atoms is no longer uniform and the localized bond strength between neighboring atoms may be increased. This increase in strength of the alloy may be due to the slight difference in size of a substitutional solute, the inclusion of an interstitional solute, and/or other reasons.

Strengthening Mechanisms in Metals

As seen with respect to the descriptions accompanying FIGS. 2A-C, there can be a plurality of ways to increase strength of a base material. The “strength” of a given material can also be described in a plurality of ways. The amount of force required to break a material is often referred to as the “tensile strength” or “ultimate tensile strength” of the material, while the amount of force required to permanently bend or deform a material may be referred to as the “yield strength” of the material. Several mechanisms may be responsible for increasing the tensile strength and/or yield strength of a given material. Such mechanisms in alloys may include, for example, changing the “smoothness” between base material layers in the alloy structure, either by introducing a substitutional solute, an interstitial solute, or a combination of substitutional and interstitial solutes. The introduction of solutes can create areas within an alloy structure that are not uniform, and may be referred to as “dislocations” within the alloy.

Dislocations may introduce different attraction and/or repulsion forces, known as stress fields, within an alloy structure. This creates a localized differential between forces within the alloy structure, known as a “pinning point,” that opposes motion of one or more base material layers of the structure proximate that pinning point.

Increasing the number of dislocations per unit of volume of the alloy structure will normally increase the tensile strength and/or yield strength of an alloy versus its base material structure in pure form. However, above a certain point, which may be different for each base material, an increased density of dislocations will begin to lower the tensile strength and/or yield strength of the alloy. If the localized differential of attractive and/or repulsive forces becomes widespread enough, it can reduce and/or eliminate any contribution of attraction and/or repulsive forces of the base material from the overall strength determination for the alloy, or it can cause the alloy structure to change form to a different underlying arrangement of the atoms in the alloy structure (e.g., from fcc to bcc, etc.).

As such, increasing the dislocation density, to a point, increases the shearing force needed to move one base material layer with respect to another. This is so because additional shearing force would be required to move the dislocations that lie within the layer(s) as well as the force needed to move the base material in those base material layers. This increase in shearing force needed to move the dislocations is exhibited as an increase in tensile strength and/or yield strength in the alloy.

However, increasing the strength of a base material may decrease other properties that the base material exhibits when the base material is in a pure form. For example, and not by way of limitation, increasing the strength may decrease the malleability of that base material. It may be known that stronger materials are harder to bend or dent. The malleability and/or elongation abilities of a material is often referred to as the “ductility” of the material. Changing how strong a material is, i.e., the ability of the material to resist force, often also changes how “workable” the material is, i.e., the ability to absorb force through deformation of the material rather than breakage of the material. Although many of the discussions herein refer to strengthening a material, in an aspect of the present disclosure, the strength of a given alloy can be improved without causing a significant effect on the ductility of the alloy.

Work Hardening

A typical structure of a pure base material may be a regular, nearly defect-free lattice. To harden a material through “work hardening,” dislocations are introduced into the base material through forming or otherwise “working” the material. These dislocations can create localized fluctuations of the stress fields in the material, which slightly rearranges the structure of the base material.

Work hardening of a base material may be achieved by applying mechanical and/or thermal stresses to the base material. For example, a sheet of Cu may be hammered, stretched, or run through pressurized rollers to reduce the material thickness. These mechanical stresses introduce dislocations into the Cu structure (which is face centered cubic). This forming of Cu increases the hardness (strength) and decreases the elasticity (commonly referred to as the “ductility”). Similar hardening can be achieved through thermal cycling, e.g., heating and cooling of the material, such as is done with furnaces and quenching of iron to “temper” the material.

As described above, if “working” a base material continues beyond a certain point, the base material will contain too large a concentration of dislocations which may result in fractures, such as micro-fractures and/or visible fractures. Such fractures may be reversible, e.g., through one or more heating and cooling cycles of the material during and/or after working of the base material. Heating and cooling of the material in such a manner may be referred to as “annealing” the base material.

Work hardening may be performed on a base material without introducing a substitutional and/or interstitial solute to form an alloy. Work hardening may also be performed on alloys that include solutes with a base material.

Solid Solution Strengthening

In an aspect of the present disclosure, a substitutional and/or interstitial solute may be added to a base material, which can result in substitutional and/or interstitial point defects in the alloy structure. The solute atoms can cause lattice distortions in the alloy structure that impede dislocation motion. When dislocation motion is impeded, the strength of the material is increased. This particular mechanism of strengthening a base material may be referred to as “solid solution strengthening.”

In solid solution strengthening, the presence of solute atoms can introduce compressive or tensile stresses to the alloy structure lattice, which may interact with nearby dislocations, causing the solute atoms to act as potential barriers to the movement of layers of the structure with respect to each other. These interactions may increase the tensile strength and/or yield strength of a given alloy.

Solid solution strengthening generally depends on the concentration of the solute atoms present in the alloy structure. Some physical properties of substitutional and/or interstitial solute atoms that may be considered when determining which particular element to include in a given alloy may be the shear modulus of the solute atoms, the physical size of solute atoms, the number of valence electrons (also known as the “valency”) of solute atoms, and the symmetry of the solute stress field, as well as other properties.

Precipitation Hardening

As a molten metal alloy cools, the base material atoms may form molecules and/or bond directly with solute(s) (or other impurities) instead of forming bonds with other base material atoms. The molecules/bonds formed between the base material and solute(s) or impurities will likely create different localized properties than in the pure base material structure and/or pure solute(s) structure. One of these properties may be the melting point of the molecule, which may be different than that of the pure base material and/or pure solute(s).

In an aspect of the present disclosure, the molecules may harden at a higher temperature than the pure base material and/or pure solute(s), which may create dislocations in the alloy structure. These dislocations may create substructures within the alloy structure that may be referred to as a different “phase” of the alloy structure. Because molecules of different sizes within the alloy structure may make it more difficult for base material layers to move with respect to each other within the alloy structure, these molecules may assist in creation of a stronger alloy.

This change in properties of the molecules, which may be referred to as a change in “solid solubility” with respect to temperature, when it affects the strength of the resultant alloy, may be referred to as a “precipitation hardening” mechanism. Because the melting points of the elements included in the alloy may be different, precipitation hardening (also known as “precipitation strengthening”) may be dependent upon temperature.

Precipitation hardening uses these changes in solid solubility with respect to temperature to produce fine particles, e.g., molecules as described above, of an impurity phase, or “second phase,” which impede the movement of dislocations. These particles that compose the second phase precipitates act as pinning points in a similar manner.

The particles may be of a similar size, or coherent size, as the base material. If the sizes of the particles and the base material are similar enough, the alloy structure can remain relatively coherent, e.g., can remain in a bcc or cubic form. However, in localized areas of the alloy structure, bowing and/or depressions may exist in the base material layers. This mechanism may be referred to as “coherency hardening” of the alloy structure, which is similar to solid solution hardening.

Where the particles have a different response to shear stress than the base material, this difference may change the tension and or internal stresses within the alloy structure. This response to shear stress is known as the “shear modulus” and because the particles can withstand a different amount of stress, the overall amount of stress that the alloy structure can withstand can be increased. This mechanism of precipitation hardening may be referred to as “modulus hardening” of the alloy structure.

Other types of precipitation hardening may be chemical strengthening and/or order strengthening, which are changes in the surface energy and/or an ordered structure of the particles within the alloy structure, respectively. Any one or more of these mechanisms may be present as a part of precipitation hardening in an alloy in an aspect of the present disclosure.

Dispersion Strengthening

Similar to precipitation hardening, changes in properties of the molecules, scattering different particles, molecules, and/or solutes within an alloy structure that are of different sizes than the base material may create dislocations within the alloy structure. Although these particles may be larger than those used for precipitation hardening, the mechanism of reducing the ability of base material layers from moving with respect to each other is similar. This mechanism may be referred to as “dispersion strengthening” to differentiate it from precipitation hardening. One type of dispersion strengthening is the introduction of an oxide of a base material in the alloy structure.

Grain Boundary Strengthening

In an aspect of the present disclosure, a unit cell of the alloy structure, e.g., one cube of an fcc, bcc, or cubic structure, etc., may be referred to as a “grain” or “crystallite” within the alloy structure. Solutes may affect the alloy structure by changing the average grain size within the alloy structure. When grains within the alloy structure have different sizes, the interface between adjacent grains, known as the “grain boundary,” acts as a dislocation within the alloy structure. Grain boundaries act as borders for dislocation movement, and any dislocation within a grain affects how stresses build up or are relaxed in adjacent grains.

Such a mechanism may be referred to as “grain boundary strengthening” of a base material in an alloy. In an aspect of the present disclosure, grains within the alloy structure may have different crystallographic orientations, e.g., bcc, fcc, cubic, etc. These differing orientations and sizes create grain boundaries within the alloy structure. When the alloy structure is subjected to external stress, slip motion between base material layers may take place. However, the grain boundaries act as an impediment to slip motion between base material layers because the base material layers do not have uniform, even surfaces where slip motion can occur.

Transformation Strengthening

As described above with respect to precipitation hardening, a base material may cool into different “phases” depending on the rate of cooling, the temperature of cooling, and/or other factors. For example, titanium (Ti) may form two different types of grains, known as α-titanium and β-titanium. α-titanium is formed when the molten titanium metal crystallizes at low temperatures, and forms a hcp lattice structure. β-titanium forms when the molten titanium crystallizes at higher temperatures, and forms a bcc lattice structure. These different structures within an overall alloy structure create a stronger alloy, because the base material layers' smooth interfaces with each other are interrupted by the change in grain size and lattice structure of the different phases of the base material and/or solute(s). This mechanism for strengthening alloys is known as “transformation strengthening.”

In an aspect of the present disclosure, transformed phases of various base materials and/or solutes may occur as a function of heating and/or cooling the resultant alloy during formation of the alloy, e.g., heating the alloy to a certain temperature, cooling the alloy at a certain rate, heat treatment, etc. In an aspect of the present disclosure, during the 3D printing process of a given alloy, the temperature of the energy beam source 103 (e.g., the amount of energy being delivered by energy beam source 103), the speed that the energy beam travels across the powder bed 121 (e.g., the speed of deflector 105), and/or other factors may be selected to supply a desired temperature profile to the powder bed 121. For example, and not by way of limitation, the heating and/or cooling of a given powder 117 may be selected to approximate a heating and/or cooling profile to create desired phases of the base materials and/or solutes in the resultant alloy, and a different heating and/or cooling of a different powder 117 may be selected to create a different temperature profile to create desired phases in that powder 117's resultant alloy. In an aspect of the present disclosure, the temperature profile(s) delivered by PBF system 100 may also take into account any post-printing heat treatments, such that the combined printing/heat treatments may be performed in a more efficient manner.

In iron (Fe) structures, high levels of carbon (C) and manganese (Mn) solutes create two different grains within the alloy structure; ferrite, which is a bcc lattice structure, and martensite, which is a body-centered tetragonal (bct) lattice structure. These differing lattices within a Fe-based alloy structure strengthen the Fe into steel, because adjacent ferrite and martensite lattice structures disrupt the planar continuity of the base material layer interfaces, and the solutes (C and Mn) act as interstitional solutes to further disrupt the base material layer planes. Depending on how the alloy is heat treated, other lattice structures of Fe, e.g., austenite (which has an fcc lattice structure), bainite (which has a slightly different sized bct lattice structure than martensite), cementite (orthorhombic Fe₃C), and/or other compounds, may also be formed.

A form of transformation strengthening, such as the creation of cementite in a Fe-based alloy structure, may also be referred to as “triferrite particle formation” within the alloy structure. Of course, if the base material is titanium, such transformation strengthening may be referred to as “tri-titanium particle formation; if the base material is aluminum (Al), such transformation strengthening may be referred to as “trialuminide particle formation,” etc. There also may be other forms of particles formed, such as a base material with two interstitial solutes or between interstitial and substitutional solutes, which may have a “di-” prefix, e.g., titanium diboride where both titanium and boron are used as solutes, etc., without departing from the scope of the present disclosure. Any number of different compounds, described with chemical prefixes, suffixes, and numerical monikers, comprising, consisting essentially of, and/or consisting base material(s) and/or solute(s) may be created within an alloy without departing from the scope of the present disclosure.

High Specific Modulus Solutes

In an aspect of the present disclosure, some structural metals, such as aluminum (Al), magnesium (Mg), titanium (Ti) may be combined with selected other elements such as beryllium (Be), chromium (Cr), ruthenium (Ru), molybdenum (Mo), manganese (Mn), boron (B), hafnium (Hf), erbium (Er), yttrium (Y), gallium (Ga), vanadium (V), zirconium (Zr), manganese (Mn), silver (Ag), silicon (Si), cerium (Ce), zinc (Zn), tungsten (W), niobium (Nb), tantalum (Ta), scandium (Sc), lanthanum (La), germanium (Ge), tin (Sn), antimony (Sb), rubidium (Rb), copper (Cu), iron (Fe), and/or other residual elements or compounds may be included without departing from the scope of the present disclosure. Some of the elements chosen may be selected based on various characteristics of the solutes (also referred to as “alloying elements” herein) and/or the base material. In an aspect of the present disclosure, the characteristics may be, for example, atomic, physical, thermo-physical, and/or other characteristics.

One characteristic that may be used as a deciding factor is the specific modulus of a solute. The specific modulus of a material is defined as the elastic modulus per mass density of the material. The elastic modulus is defined as a material's resistance to being deformed elastically (non-permanently) when a stress is applied to it. “Stiffer” materials have higher elastic moduli. Selecting materials that have a relatively high specific modulus may increase the strength per unit weight of the resultant alloy.

Another characteristic that may be used as a deciding factor is an operating temperature of the material. Operating temperature or “use temperature” as used herein means the temperature of the material in operation in a given application. For example, and not by way of limitation, in an internal combustion engine, temperatures of the engine block, pistons, etc. may reach temperatures of 300 degrees Celsius (° C.). Although pure aluminum would not necessarily change state from solid to liquid, however, the deformation of aluminum at such temperatures may affect the operation of the engine. As such, alloys of aluminum have been used to avoid such deleterious effects of operating temperature on the material.

For example, and not by way of limitation, a device made from a given material may be exposed to high temperatures, e.g., temperatures of 150° C. to 350° C., which may be a significant percentage of the melting point of the material. The melting point (i.e., the point where the material changes from a solid to a liquid state) is 660.32° C. (1,221 degrees Fahrenheit (° F.)). Pure aluminum parts are often not used in situations where the temperature of the material during operation (known as the “operating temperature” or “use temperature”) is above a certain temperature. This limit of operating temperature may be expressed as a percentage of the melting point, which in the case of aluminum, is in excess of 30 percent (%) of the melting point (i.e., 198° C.). Alloys in accordance with an aspect of the present disclosure may be used at operating temperatures of up to 55% of the melting point of the alloy.

In an aspect of the present disclosure, alloys that are manufactured using additive manufacturing techniques (e.g., such as those described with respect to FIGS. 1A-1E) may have different strength and elasticity properties, as well as increased operating temperatures, different elastic moduli, etc., than those made by smelting or other alloy manufacturing techniques. Such differences may be due to differences in heating/cooling profiles in the final alloy when additive manufacturing processes are involved.

In an aspect of the present disclosure, high specific modulus alloys (also known as high “stiffness to weight ratio” alloys) can be manufactured using additive manufacturing techniques that may not be possible to manufacture using smelting and machining processes. In an aspect of the present disclosure, such alloys may also have more uniform strength and elasticity properties, as the percentages of base materials and alloying materials may be more precisely controlled in each produced part rather than in a large lot of material. In an aspect of the present disclosure, some combinations of materials may go beyond a strict definition of “alloy” in that they may be technically considered ceramics or ceramic-metals. In the present disclosure, “alloy” is to include such combinations of materials, even when the addition of solutes to a base material goes beyond the technical definition of “alloy.”

In an aspect of the present disclosure, selection of one or more materials having desired specific moduli may produce alloys that can support structures having reduced overall weight. For example, and not by way of limitation, in some design processes, a main concern of the design may be the deflection, elongation, or physical deformation of the material, rather than the overall tensile strength of the material. Such a design may be referred to as a “stiffness-driven” design. Examples of structures that can be stiffness driven are airplane wings, bicycle frames, beams in automobiles or buildings, etc. In an aspect of the present disclosure, alloying base materials with one or more high specific modulus materials allows for changes in the strength and/or elongation of the base material without significantly changing the density of the base material, thus increasing the specific modulus of the resultant alloy.

Alloy Compositions

In an aspect of the present disclosure, one or more base materials may be used to create an alloy. For example, and not by way of limitation, aluminum (Al) may be used as the base material; however, Al may be mixed with other materials, such as nickel (Ni), copper (Cu), titanium (Ti), iron (Fe), cobalt (Co), molybdenum (Mo), magnesium (Mg), chromium (Cr), and/or other materials, e.g., high entropy alloy (HEA) materials, etc., can be used by themselves as the base material. Other base materials, such as magnesium (Mg) or titanium (Ti) may also be used without departing from the scope of the present disclosure.

In an aspect of the present disclosure, one or more solutes may also be included in an alloy. For example, and not by way of limitation, magnesium (Mg), molybdenum (Mo), beryllium (Be), manganese (Mn), silicon (Si), ruthenium (Ru), lanthanum (La), germanium (Ge), tin (Sn), yttrium (Y), zirconium (Zr), antimony (Sb), rubidium (Rb), titanium (Ti), copper (Cu), iron (Fe), and/or other residual elements or compounds may be included without departing from the scope of the present disclosure.

In an aspect of the present disclosure, solutes may be added to the base material to change the tensile strength of the base material. In an aspect of the present disclosure, solutes may be added to the base material to change the tensile strength of the base material, but the introduction of solutes to the base material may not have a corresponding effect in reducing the ductility of the base material. In an aspect of the present disclosure, solutes may be added to the base material to modify the structure of the base material through one or more of work hardening, solid solution strengthening, precipitation hardening, dispersion strengthening, grain boundary strengthening, and/or transformation strengthening (e.g., promotion of trialuminide particle formation, triferrite particle formation, and/or other transformations) without departing from the scope of the present disclosure.

As used herein, a percentage mass of a solute in an alloy equals the mass of the solute divided by the mass of the alloy and multiplied by 100, and may be designated as “wt %” or “percent by weight” herein.

Aluminum-Magnesium-Titanium Base Alloy

In an aspect of the present disclosure, a base composition of an alloy may include aluminum (Al), magnesium (Mg), and titanium (Ti), and one or more solutes included with the base composition. In an aspect of the present disclosure, Al may be a significant wt % of the base composition. For example, in various embodiments Al may be the remaining proportion of the alloy (i.e., balance Al). In such an aspect, the base composition may be referred to as an “Al—Mg—Ti” or “AMT” base composition herein. Even though in some embodiments the wt % of Mg and/or Ti may be zero, the base composition will be referred to as AMT herein.

The one or more solutes included in the Al—Mg—Ti base alloy may include one or more of beryllium (Be), chromium (Cr), molybdenum (Mo), ruthenium (Ru), manganese (Mn), silicon (Si), cerium (Ce), yttrium (Y), and zirconium (Zr), as well as other solutes.

In an aspect of the present disclosure, the Al—Mg—Ti base composition may include Mg in a proportion of 0-18 wt % and Ti in a proportion of 0-18 wt %. In various embodiments, the Al—Mg—Ti base composition may include Mg in a proportion of 4-15 wt % and Ti in a proportion of 0-15 wt %. In various embodiments, the Al—Mg—Ti base composition may include Mg in a proportion of 6-10 wt % and Ti in a proportion of 0.3-3 wt %.

In an aspect of the present disclosure, Al may be used as a base material to form an alloy structure of an alloy. Pure, fine-grained aluminum can exhibit an fcc lattice structure, and some process methods may result in a pure aluminum with a tensile strength of approximately 70 megapascals (A/Pa), an elastic modulus (also known as “Young's Modulus”) of 55.5 gigapascals (GPa), a density of 2.7 grams/cubic centimeter (g/cm³), and an elongation of approximately 10 percent (%). The specific stiffness of Al is 20.55 in units of 10⁶ m²/second².

In an aspect of the present disclosure, an AMT alloy can include aluminum, magnesium, and/or titanium as the base material(s), and Be, Cr, Mo, Ru, and/or Mn may be added as solutes to the alloy in a proportion of 0-50.0 wt %, individually or in combination to the base material, individually or in combination, as alloying elements.

In another aspect of the present disclosure, Si, Ce, Y, and/or Zr may be added as solutes to the alloy in a proportion of 0-50.0 wt %, individually or in combination. Other proportions of the above-named solutes, and/or other solutes, may also be used, without departing from the scope of the present disclosure.

In such aspects of the present disclosure, the solute(s) added to the base material(s) may increase the elastic modulus of the AMT alloy to at least 65 GPa. The resultant alloy may also have an increased tensile strength, but the addition of the solute(s) may also change another property of the base material. For example, and not by way of limitation, the elongation of the resultant alloy may be reduced to 9%, or 8%, or may be increased up to 12%, 14%, 16%, the operating temperature may be increased to 50% of the melting point of aluminum, etc.

In such an aspect, depending on the wt % of Ti, Al, and Mg in the AMT alloy, the elastic modulus of the AMT alloy may be increased to even higher values, e.g., at least 67 GPa, at least 68 GPa, at least 69 GPa, at least 71 GPa, at least 73 GPa, at least 75 GPa, etc., without departing from the scope of the present disclosure. Addition of one or more additional solutes to the AMT alloy may also affect the value of the elastic modulus. For example, and not by way of limitation, combining one or more additional solutes to the AMT alloy may increase the elastic modulus of the final alloy to at least 80 GPa. Addition of one or more additional solutes to the AMT alloy may further increase the elastic modulus to at least 90 GPa, at least 100 GPa, at least 150 GPa, at least 175 GPa, at least 200 GPa, at least 250 GPa, at least 275 GPa, etc., without departing from the scope of the present disclosure.

Titanium-Magnesium-Aluminum Base Alloy

In another aspect of the present disclosure, Ti may be a significant wt % of the base composition. For example, in various embodiments Al may be the remaining proportion of the alloy (i.e., balance Ti). In such an aspect, the base composition may be referred to as an “Ti—Mg—Al” or “TMA” base composition herein. Even though in some embodiments the wt % of Mg and/or Al may be zero, the base composition will be referred to as TMA herein. In such an aspect of the present disclosure, the Ti—Mg—Al base composition may include Al in a proportion of 0-25 wt %, and Mg in a proportion of 0-10 wt %. In various embodiments, the Ti—Mg—Al base composition may include Al in a proportion of 5-20 wt %, and Mg in a proportion of 0-7 wt %. In various embodiments, the Ti—Mg—Al base composition may include Al in a proportion of 7-13 wt %, and Mg in a proportion of 5-7 wt %.

The one or more solutes included in the Ti—Mg—Al base alloy may include one or more of beryllium (Be), chromium (Cr), molybdenum (Mo), ruthenium (Ru), manganese (Mn), silicon (Si), cerium (Ce), yttrium (Y), and zirconium (Zr), as well as other solutes.

Pure titanium can crystallize in two crystal structures: alpha (α) titanium and beta (β) titanium. When titanium crystallizes at low temperatures (e.g., room temperature), titanium forms a hexagonal close-packed (HCP) structure known as alpha titanium. When titanium crystallizes at high temperatures, titanium forms a body-centered cubic (BCC) structure known as beta titanium.

In an aspect of the present disclosure, Ti may be used as a base material to form an alloy structure of an alloy. Some classes of pure titanium have, for example, a melting point of approximately 2758° C., a tensile strength of approximately 240 megapascals (MPa), an elastic modulus of 100 GPa, a density of 4.5 g/cm³, and an elongation of approximately 25%.

In an aspect of the present disclosure, a TMA alloy can include aluminum, magnesium, and/or titanium as the base material(s), and Be, Cr, Mo, Ru, and/or Mn may be added as solutes to the alloy in a proportion of 0-50.0 wt %, individually or in combination to the base material, individually or in combination, as alloying elements.

In another aspect of the present disclosure, Si, Ce, Y, and/or Zr may be added as solutes to the alloy in a proportion of 0-50.0 wt %, individually or in combination. Other proportions of the above-named solutes, and/or other solutes, may also be used, without departing from the scope of the present disclosure.

In such aspects of the present disclosure, the solute(s) added to the base material(s) may increase the elastic modulus of the TMA alloy to at least 100 GPa. The resultant alloy may also have an increased tensile strength, but the addition of the solute(s) may also change another property of the base material. For example, and not by way of limitation, the elongation of the resultant alloy may be reduced to 9%, or 8%, or may be increased up to 12%, 14%, 16%, the operating temperature may be increased to 50% of the melting point of aluminum, etc.

In such an aspect, depending on the wt % of Ti, Al, and Mg in the TMA alloy, the elastic modulus of the TMA alloy may be increased to even higher values, e.g., at least 105 GPa, at least 107 GPa, at least 109 GPa, at least 111 GPa, at least 113 GPa, etc., without departing from the scope of the present disclosure. Addition of one or more additional solutes to the TMA alloy may also affect the value of the elastic modulus. For example, and not by way of limitation, combining one or more additional solutes to the TMA alloy may change the elastic modulus of the final alloy to at least 70 GPa. Addition of one or more additional solutes to the TMA alloy may further change the elastic modulus to at least 80 GPa, at least 100 GPa, at least 150 GPa, at least 175 GPa, at least 200 GPa, at least 250 GPa, at least 275 GPa, etc., without departing from the scope of the present disclosure.

In an aspect of the present disclosure, the solute(s) added to the base material(s) may increase the elastic modulus of the TMA alloy to at least 100 GPa. The resultant alloy may also have an increased tensile strength, but the addition of the solute(s) may also change another property of the base material. For example, and not by way of limitation, the elongation of the resultant alloy may be reduced to 9%, or 8%, or may be increased up to 12%, 14%, 16%, the operating temperature may be increased to 55% of the melting point of titanium, etc.

The addition of other solutes to the AMT alloy or the TMA alloy may also increase the elastic modulus of the final alloy.

High Modulus Alloys

In an aspect of the present disclosure, a selected number and range of wt % of solutes may be added to a base material to create a resultant alloy. Such a resultant alloy may have particular properties that may be desirable in a particular application, e.g., higher tensile strength, different specific modulus, higher or lower elasticity, better temperature resistance, etc.

Beryllium-Silicon/Cerium/Zirconium Solutes

In an aspect of the present disclosure, a percentage mass of beryllium (Be) and a percentage mass of a ratio of silicon (Si) and/or cerium (Ce) and/or Zirconium (Zr) may be added as solutes to a base material.

In an aspect of the present disclosure, an aluminum alloy may include AMT as a base material, and may include Be in a proportion of 0-12 wt % and a ratio of Si and/or Ce and/or Zr in a total proportion of 0-12 wt %. In an aspect of the present disclosure, an aluminum alloy may include AMT as a base material, and may include Be in a proportion of 3-4 wt % and a ratio of Si and/or Ce and/or Zr in a total proportion of 0.9-3 wt %. In various embodiments, an aluminum alloy may include AMT as a base material with Mg in a proportion of 2.5-4.5 wt %, and may include Be in a proportion of 4.5-6 wt % and a ratio of Si and/or Ce and/or Zr in a proportion of 0.8-2 wt %. In other embodiments, the AMT base material may include Mg in a proportion of 4.0-15.0 wt %, and may include Be in a proportion of 3.0-12.0 wt % and a ratio of Si and/or Ce and/or Zr in a proportion of 0.0-3.0 wt %. The ratio of Si and/or Ce and/or Zr in the embodiments may be any possible combination. In such an aspect, Si, Ce, and Zr may act as substitutional solutes, and Be may act as an interstitial solute. Other solutes may be included in such an alloy to further alter one or more desired properties of the alloy without departing from the scope of the present disclosure.

When an alloy is described as having solutes added to a base material in this disclosure, this means an alloy according to this aspect may include elements in proportions described above with respect to the base material and elements in proportions described as solutes. For example, for an aluminum alloy including AMT as a base material and including Be in a proportion of 0-12 wt % and a ratio of Si and/or Ce and/or Zr in a total proportion of 0-12 wt %, the composition may include any of the following examples. Example 1: Mg in a range of 0-18 wt %, Ti in a range of 0-18 wt %, Be in a proportion of 0-12 wt %, and a ratio of Si and/or Ce and/or Zr in a total proportion of 0-12 wt %. Example 2: Mg in a range of 4-15 wt %, Ti in a range of 0-15 wt %, Be in a proportion of 0-12 wt %, and a ratio of Si and/or Ce and/or Zr in a total proportion of 0-12 wt %. Example 3: Mg in a range of 6-10 wt %, Ti in a range of 0.3-3 wt %, Be in a proportion of 0-12 wt %, and a ratio of Si and/or Ce and/or Zr in a total proportion of 0-12 wt %.

In an aspect of the present disclosure, a titanium alloy may include TMA as a base material, and may include Be in a proportion of 0-3 wt % and a ratio of Si and/or Ce and/or Zr in a total proportion of 0-5 wt %. In an aspect of the present disclosure, a titanium alloy may include TMA as a base material, and may include Be in a proportion of 1.5-2.5 wt % and a ratio of Si and/or Ce and/or Zr in a total proportion of 0.1-0.9 wt %. The ratio of Si and/or Ce and/or Zr in the embodiments may be any possible combination. In such an aspect, Si, Ce, and Zr may act as substitutional solutes, and Be may act as an interstitial solute. Other solutes may be included in such an alloy to further alter one or more desired properties of the alloy without departing from the scope of the present disclosure.

Other proportions of Be and Si/Ce/Zr may also be used with AMT and TMA base materials, depending on which other solutes are included in the final alloy, without departing from the scope of the present disclosure.

Chromium-Ruthenium-Silicon/Cerium/Zirconium Solutes

In an aspect of the present disclosure, a percentage mass of chromium (Cr), a percentage mass of Ruthenium, and a percentage mass of silicon (Si) and/or Cerium (Ce) and/or Zirconium (Zr) may be added as solutes to a base material.

In an aspect of the present disclosure, an aluminum alloy may include AMT as a base material, and may include Cr in a proportion of 0-25 wt %, Ru in a proportion of 0-40 wt %, and a ratio of Si and/or Ce and/or Zr in a total proportion of 1-15 wt %. In an aspect of the present disclosure, an aluminum alloy may include AMT as a base material, and may include Cr in a proportion of 15-20 wt %, Ru in a proportion of 15-20 wt %, and a ratio of Si and/or Ce and/or Zr in a total proportion of 1-12 wt %. The ratio of Si and/or Ce and/or Zr in the embodiments may be any possible combination. In such an aspect, Cr, Ru, and Si/Ce/Zr may act as substitutional solutes. Other solutes may be included in such an alloy to further alter one or more desired properties of the alloy without departing from the scope of the present disclosure.

In an aspect of the present disclosure, a titanium alloy may include TMA as a base material, and may include Cr in a proportion of 20-50 wt %, Ru in a proportion of 0-10 wt %, and a ratio of Si and/or Ce and/or Zr in a total proportion of 1-10 wt %. In an aspect of the present disclosure, a titanium alloy may include TMA as a base material, and may include Cr in a proportion of 20-25 wt %, Ru in a proportion of 8-10 wt %, and a ratio of Si and/or Ce and/or Zr in a total proportion of 1-5 wt %. The ratio of Si and/or Ce and/or Zr in the embodiments may be any possible combination. In such an aspect, Si, Ce, and Zr may act as substitutional solutes, and Be may act as an interstitial solute. Other solutes may be included in such an alloy to further alter one or more desired properties of the alloy without departing from the scope of the present disclosure.

Other proportions of Chromium, Ruthenium, and Silicon/Cerium/Zirconium may also be used with AMT and TMA base materials, depending on which other solutes are included in the final alloy, without departing from the scope of the present disclosure.

Yttrium-Silicon/Cerium/Zirconium Solutes

In an aspect of the present disclosure, a percentage mass of yttrium (Y) and a percentage mass of silicon (Si) and/or Cerium (Ce) and/or Zirconium (Zr) may be added as solutes to a base material.

In an aspect of the present disclosure, an aluminum alloy may include AMT as a base material, and may include Y in a proportion of 0-3 wt % and a ratio of Si and/or Ce and/or Zr in a total proportion of 0-3 wt %. In an aspect of the present disclosure, an aluminum alloy may include AMT as a base material, and may include Y in a proportion of 0.3-1 wt % and a ratio of Si and/or Ce and/or Zr in a total proportion of 0.9-1.5 wt %. The ratio of Si and/or Ce and/or Zr in the embodiments may be any possible combination. In such an aspect, Y, Si, Ce, and Zr may act as substitutional solutes. Other solutes may be included in such an alloy to further alter one or more desired properties of the alloy without departing from the scope of the present disclosure.

In an aspect of the present disclosure, a titanium alloy may include TMA as a base material, and may include Y in a proportion of 20-50 wt % and a ratio of Si and/or Ce and/or Zr in a total proportion of 0-5 wt %. In an aspect of the present disclosure, a titanium alloy may include TMA as a base material, and may include Y in a proportion of 20-30 wt % and a ratio of Si and/or Ce and/or Zr in a total proportion of 4-5 wt %. The ratio of Si and/or Ce and/or Zr in the embodiments may be any possible combination. In such an aspect, Y, Si, Ce, and Zr may act as substitutional solutes. Other solutes may be included in such an alloy to further alter one or more desired properties of the alloy without departing from the scope of the present disclosure.

Other proportional additions of Y and Si/Ce/Zr may also be used with AMT and TMA base materials, depending on which other solutes are included in the final alloy, without departing from the scope of the present disclosure.

Beryllium-Chromium-Manganese-Molybdenum/Ruthenium Solutes

In an aspect of the present disclosure, a percentage mass of beryllium (Be), a percentage mass of chromium (Cr), a percentage mass of manganese (Mn), and a percentage mass of a ratio of molybdenum (Mo) and/or Ruthenium (Ru) may be added as solutes to a base material.

In an aspect of the present disclosure, an aluminum alloy may include AMT as a base material, and may include Be in a proportion of 0-12 wt %, Cr in a proportion of 10-25 wt %, Mn in a proportion of 0-15 wt %, and a ratio of Mo and/or Ru in a total proportion of 0-20 wt %. In an aspect of the present disclosure, an aluminum alloy may include AMT as a base material, and may include Be in a proportion of 5-9 wt %, Cr in a proportion of 12-15 wt %, Mn in a proportion of 12-15 wt %, and a ratio of Mo and/or Ru in a total proportion of 15-18 wt %. The ratio of Mo and/or Ru in the embodiments may be any possible combination. In such an aspect, Cr, Mn, Mo, and Ru may act as substitutional solutes, and Be may act as an interstitial solute. Other solutes may be included in such an alloy to further alter one or more desired properties of the alloy without departing from the scope of the present disclosure.

In an aspect of the present disclosure, a titanium alloy may include TMA as a base material, and may include Be in a proportion of 0-5 wt %, Cr in a proportion of 20-50 wt %, Mn in a proportion of 3-20 wt %, and a ratio of Mo and/or Ru in a total proportion of 5-25 wt %. In an aspect of the present disclosure, a titanium alloy may include TMA as a base material, and may include Be in a proportion of 4-5 wt %, Cr in a proportion of 25-30 wt %, Mn in a proportion of 15-20 wt %, and a ratio of Mo and/or Ru in a total proportion of 12-18 wt %. The ratio of Mo and/or Ru in the embodiments may be any possible combination. In such an aspect, Cr, Mn, Mo, and Ru may act as substitutional solutes, and Be may act as an interstitial solute. Other solutes may be included in such an alloy to further alter one or more desired properties of the alloy without departing from the scope of the present disclosure.

Other proportions of Be, Cr, Mn, and Mo/Ru may also be used with AMT and TMA base materials, depending on which other solutes are included in the final alloy, without departing from the scope of the present disclosure.

Material Properties

In various embodiments of the AMT and TMA alloys described above, the solute(s) added to the base material(s) may increase the elastic modulus of the final alloy to at least 80 GPa. The resultant alloy may also have an increased tensile strength, but the addition of the solute(s) may also change another property of the base material. For example, and not by way of limitation, the elongation of the resultant alloy may be reduced to 9%, or 8%, or may be increased up to 12%, 14%, 16%, the operating temperature may be increased to 50% of the melting point of aluminum, etc.

In such an aspect, depending on the wt % of the base material(s) and solutes in the final alloy, the elastic modulus of the final alloy may be increased to even higher values, e.g., at least 90 GPa, at least 100 GPa, at least 105 GPa, at least 110 GPa, at least 115 GPa, etc., without departing from the scope of the present disclosure. Addition of one or more additional solutes to the final alloy may also affect the value of the elastic modulus. For example, and not by way of limitation, combining one or more additional solutes to the final alloy may change the elastic modulus of the final alloy to at least 70 GPa but increase the operational temperature of the final TMA alloy to at least 550° C., at least 555° C., at least 560° C., at least 565° C., at least 570° C., at least 575° C., at least 580° C., or at least 600° C. For the AMT alloy, the operational temperature may increase to at least 180° C., at least 185° C., at least 190° C., at least 195° C., at least 200° C., at least 210° C., or at least 220° C. Addition of one or more additional solutes to the final alloy may further change the operational temperature to above these ranges without departing from the scope of the present disclosure.

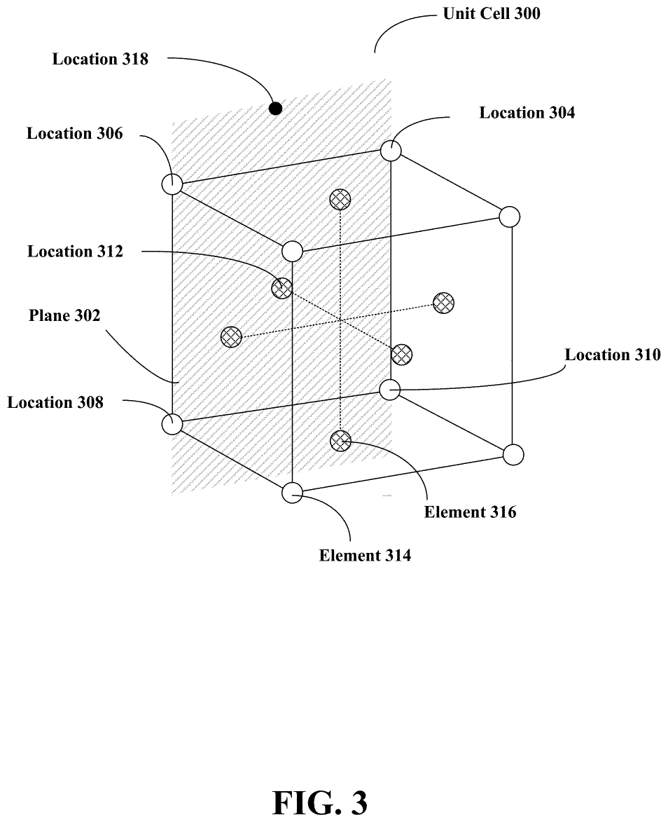

FIG. 3 illustrates a unit cell of a structure in accordance with an aspect of the present disclosure.

Unit cell 300 shows a single cube of an alloy structure, which, as illustrated in FIG. 3, is a face centered cubic (fcc) structure. For ease of understanding plane 302 is shown, although unit cell 300 has six planes that are approximately perpendicular to each other at each intersection. Other unit cells 300 are possible, e.g., bcc, cubic, hcp, etc., without departing from the scope of the present disclosure.

Plane 302 is described by five atomic locations: location 304, location 306, location 308, and location 310, which define the “corners” of plane 302, and location 312, which defines the “center” of plane 302 within the face of the unit cell closest to the viewer. In an alloy structure, one unit cell 300 may be adjacent to another unit cell 300, etc., such that a large array of unit cells 300 defines the alloy structure.

An element 314 is located in this example at each of the corners of unit cell 300, including at locations 304, 306, 308, and 310 of plane 302. An element 316 is located at the center of each one of the six planes, including at location 312. That is, as shown in FIG. 3, locations 304-310 are occupied by element 314, and location 312 is occupied by element 316. Element 314 may be the same material/element as element 316, or may be a different material/element depending on the composition of the resultant alloy. In an alloy structure with unit cells 300 of a pure material, e.g., aluminum, each location 304-310 and location 312 would be occupied by aluminum. If a substitutional solute were introduced as an alloying material for pure aluminum, then one or more locations 304-312 may be occupied by the alloying material, e.g., vanadium, chromium, etc. If an interstitial solute were added as an alloying material for pure aluminum, such a solute may be located, for example, location 318. Location 318 is between location 306 and location 304, and in an aspect of the present disclosure, within plane 302. Other locations for an interstitial solute are possible without departing from the scope of the present disclosure.

Aluminum, which has an fcc unit cell as shown in FIG. 3, has been alloyed with various solutes. Some aluminum alloys have been standardized and named based on which solute(s) are included in the named alloy. For example, and not by way of limitation, the International Alloy Designation System (TADS) is a widely-accepted naming scheme for aluminum alloys, where each alloy is referred to using a four-digit number. The first digit of the number indicates the major solute elements included in the alloy. The second digit indicates any variants for that solute alloy, and the third and fourth digits identify a specific alloy in that series.

For aluminum alloys named (i.e., numbered) in the IADS, 1000 series alloys are essentially pure aluminum content by wt %, and the other digits represent various applications for such alloys. 2000 series aluminum alloys are alloyed with Cu, 3000 series aluminum alloys are alloyed with Mn, 4000 series aluminum alloys are alloyed with silicon (Si), 5000 series aluminum alloys are alloyed with Mg, 6000 series aluminum alloys are alloyed with Mg and Si, 7000 series aluminum alloys are alloyed with Zn, and 8000 series aluminum alloys are alloyed with other elements or a combination of elements that are not covered by other series designations. As an example, and not by way of limitation, a common aluminum alloy is referred to as “6061” which, per the IADS naming scheme, has Mg and Si as the major alloying solutes. However, 6061 has other alloying solutes, in various percentages, e.g., iron (Fe), copper (Cu), chromium (Cr), zinc (Zn), titanium (Ti), and manganese (Mn), and is allowed to have other solutes, which may be referred to as “impurities,” of less than a certain percentage. The solutes present in 6061 may have a range of wt % depending on the application, manufacturer, alloying tolerances, and/or other reasons.

However, when the manufacturing process of creating such alloys is changed from smelting, forging, and/or casting to 3-D printing, the formation of the alloy structure and/or unit cells 300 within the alloy structure becomes localized. Since 3-D printing only applies thermal energy to a small portion of the overall alloy structure at any given time, the formation of unit cells 300 happens on a local scale in a build piece 109 instead of on a global scale, for example, in a cast piece. As a result of the local versus global thermal energy application, and local versus global cooling of the build piece 109, it has been seen that some named, common alloys of aluminum are difficult to 3-D print without introducing micro-fractures and/or other deleterious structural defects in the build piece 109.

In an aspect of the present disclosure, any one or more of the alloys described herein may be combined with a known aluminum alloy, e.g., combined with alloy 2195, alloy 2218, alloy 2519, alloy 6060, alloy 6061, alloy 7010, etc., which may allow for 3-D printing of an aluminum alloy that is difficult to 3-D print. For example, and not by way of limitation, powdered forms of alloy 6061 (or any other IADS named alloy) and an alloy described in accordance with an aspect of the present disclosure may be mixed together and placed into hopper 115, and the build process described in FIGS. 1A-1E of the present disclosure may be undertaken for that combination of alloys, which can create a new alloy when fused. In such an aspect, a mixed metal composite, hybrid alloy, and/or quasi-alloy that may have similar characteristics to the IADS numbered alloy may be created.

In an aspect of the present disclosure, when such an alloy is 3D printed as described with respect to FIGS. 1A-1E, some of the solutes in the powder 117 used to create the resultant alloy may be vaporized and/or otherwise removed from the resultant alloy without departing from the scope of the present disclosure. In such an aspect, the percentages of individual solutes and/or base materials may change from those used in the powder 117. In such an aspect, the percentages described herein may refer to the final percentages of base materials and/or solutes in the final printed material and/or may describe the percentages of base materials and/or solutes in the powder 117.

In an aspect of the present disclosure, different percentages of each alloy powder material may be used, e.g., one embodiment can include 50% of one of the alloys described in the present disclosure and 50% alloy 2195, another embodiment can include 25% of one of the alloys described in the present disclosure, 25% alloy 6061, 25% of another alloy described in the present disclosure, etc.

For example, and not by way of limitation, in an aspect of the present disclosure, alloy 2195 may be combined with one or more alloys described herein. Alloy 2195 is a relatively complex alloy, in that there are a number of solutes included in alloy 2195. In being consistent with the IADS naming schedule, alloy 2195 has Cu as a major alloying solute. However, alloy 2195 may also include, for example, lithium (Li), magnesium (Mg), silver (Ag), zirconium (Zr), iron (Fe), silicon (Si), and zinc (Zn) at or below certain wt % of the final alloy material, and other residual solutes at less than a certain wt % of the final alloy material, while still retaining the moniker “alloy 2195.” The total percentage of solutes in such combination of alloy 2195 and one or more alloys described herein may have a maximum wt % of the overall alloy, e.g., no more than 20%, no more than 10%, no more than 9%, no more than 8%, no more than 7%, etc., without departing from the scope of the present disclosure.

In an aspect of the present disclosure, powders, oxides, components, and/or precursors of elements included in an alloy of the present disclosure may be mixed with powders of the base material and solutes of alloy 2195 such that this mixture of powders can be printed using 3-D printing techniques such as those described in FIGS. 1A-1E of the present disclosure.

The percentages of the base alloy and alloy 2195 may be varied in different mixtures of powder 117, e.g., one mixture of powder 117 may include 50% of an alloy powder described as an aspect of the present disclosure and 50% alloy 2195 powder, another mixture of powder 117 may include 25% an alloy powder described as an aspect of the present disclosure and 75% alloy 2195 powder, etc., without departing from the scope of the present disclosure. The total percentage of all of the solutes may have a maximum wt % of the overall alloy, e.g., no more than 40 wt %, no more than 30 wt %, no more than 20 wt %, no more than 10 wt %, no more than 9 wt %, etc., without departing from the scope of the present disclosure.

In an aspect of the present disclosure, the blending of an alloy powder described as an aspect of the present disclosure and alloy 2195 powder 117 into a homogenous mixture may allow for 3-D printing resulting in an alloy that is a combination of the alloy powder described as an aspect of the present disclosure and alloy 2195. Depending on the percentages of each alloy combined into the resultant alloy, the strength and/or ductility of the final material may be similar to alloy 2195, and thus, the resultant alloy may allow for an alloy similar to alloy 2195 in terms of performance characteristics to be 3-D printed.

In another aspect of the present disclosure, an alloy powder described as an aspect of the present disclosure may be blended with multiple IADS named alloys, such that the performance characteristics of the final material may be tailored to a given application. Many possibilities of blending of alloys in powder form to create a combination powder 117 using alloy(s) of the present disclosure, variants of the alloy(s) of the present disclosure, and IADS-named alloys are possible within the scope of the present disclosure.

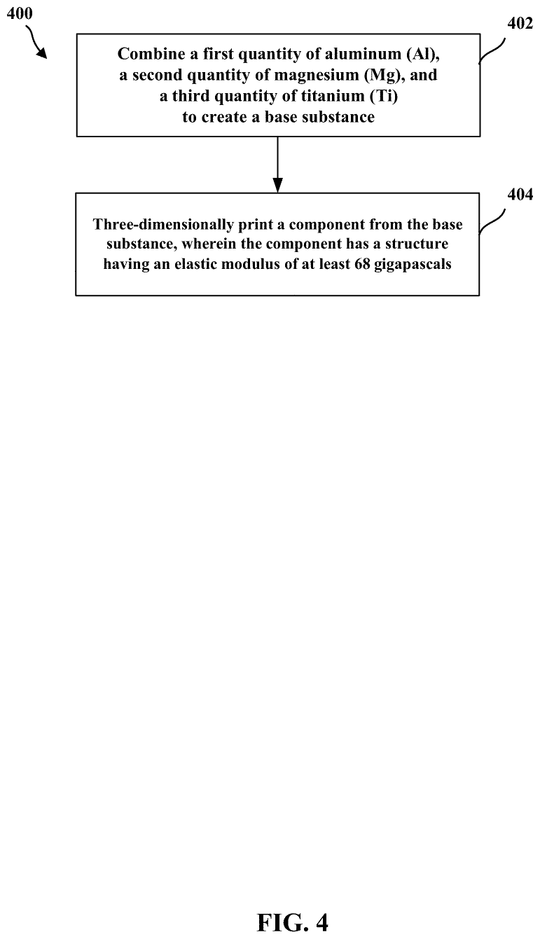

FIG. 4 shows a flow diagram illustrating an exemplary method 400 for additively manufacturing a component in accordance with an aspect of the present disclosure. The additive manufacturing may be three-dimensional printing, or may be another additive manufacturing process. The objects that perform, at least in part, the exemplary functions of FIG. 4 may include, for example, computer 150 and one or more components therein, a three-dimensional printer, such as illustrated in FIGS. 1A-E, and other objects that may be used for forming the above-referenced materials.

It should be understood that the steps identified in FIG. 4 are exemplary in nature, and a different order or sequence of steps, and additional or alternative steps, may be undertaken as contemplated in this disclosure to arrive at a similar result.

At 402, a first quantity of aluminum (Al), a second quantity of magnesium (Mg), and a third quantity of titanium (Ti) are combined to create a base substance.

At 404, a component is three-dimensionally printed from the base substance, wherein the component has a structure having an elastic modulus of at least 68 gigapascals (GPa).

One of the advantages of metal Additive Manufacturing is that this process allows weight reduction of metallic products without sacrificing the performance. This in turn saves material, energy, and cost of all products. Currently this is done with design through topological optimization. During design of structural products, especially when optimizing the geometry, the mass of the part is load critical or stiffness critical. To obtain the best performance in load critical parts the strength of the material is key and is available for myriads of materials and processing conditions.

The stiffness critical parts, on the other hand, requires materials with high elastic modulus to improve design and use less material for design optimization. Unlike material strength properties elastic modulus of a material is an intrinsic property which solely depends on major chemical composition of the material, not on the processing methods such as heat treatment. This is the reason all steels has same elastic modulus, no matter what the strength is. With very few number of metal AM alloys available today, it is very hard to design products that are stiffness critical. This gap in metal AM materials necessitates development of High Modulus Light Alloys.

The aspects of the present disclosure will help solve the problem of designing stiffness critical light weight parts for automotive, aerospace and other industries. Currently there is no technology to replace as the design is performed by selecting available materials with best specific modulus and then optimize load performance with processing variations such as heat treatment or manufacturing method (forging, casting, welding etc.) The present disclosure describes materials that may allow topological optimization based on the desired elastic modulus of many materials with varying modulus.

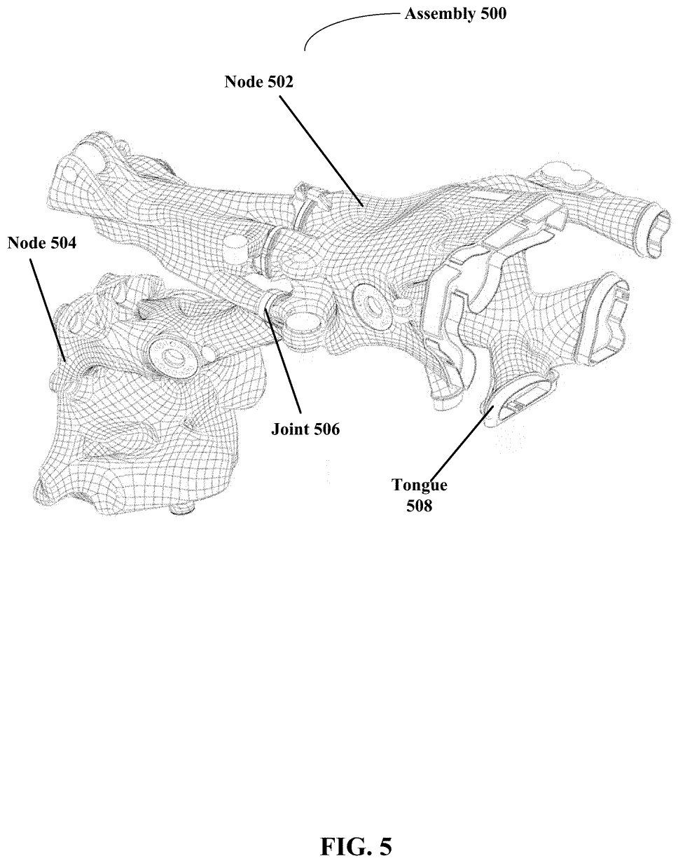

FIG. 5 illustrates an assembly in accordance with an aspect of the present disclosure.

FIG. 5 illustrates assembly 500, which includes at least node 502 and node 504. Node 502 and node 504 are coupled at one or more joints 506. Joint 506 may include various types of structures, one of which is shown as tongue 508 in FIG. 5.

In an aspect of the present disclosure, additive manufacturing allows for manufacturing of complex structures, such as node 502, node 504, etc., for vehicle structures. Assembly 500 may include, for example, a chassis structure (such as a rear subframe, etc.), a crash structure (such as a bumper, crash rail, etc.), a suspension structure (such as a control arm, etc.), or other vehicle structure. In such an aspect, multi-part nodes are additively manufactured and then may be coupled together, either through manual assembly or in an automated assembly cell, to form assembly 500. In alternate embodiments, the alloys described herein may be used to additively manufacture integrated components, such as heat exchangers.

In an aspect of the present disclosure, vehicle assemblies, subassemblies, etc. may be additively manufactured. These assemblies, subassemblies, etc., may be combined with other components, parts, etc., to create a larger assembly such as a vehicle. As shown in FIG. 5, an aspect of the present disclosure may include a vehicle structure, which may include nodes 502 and 504, that are coupled together at one or more joints 506. Such joints 506 may also include tongue 508 that is coupled to a groove in an adjoining node. The joints 506 may incorporate one or more structural adhesives to structurally couple joint 506.

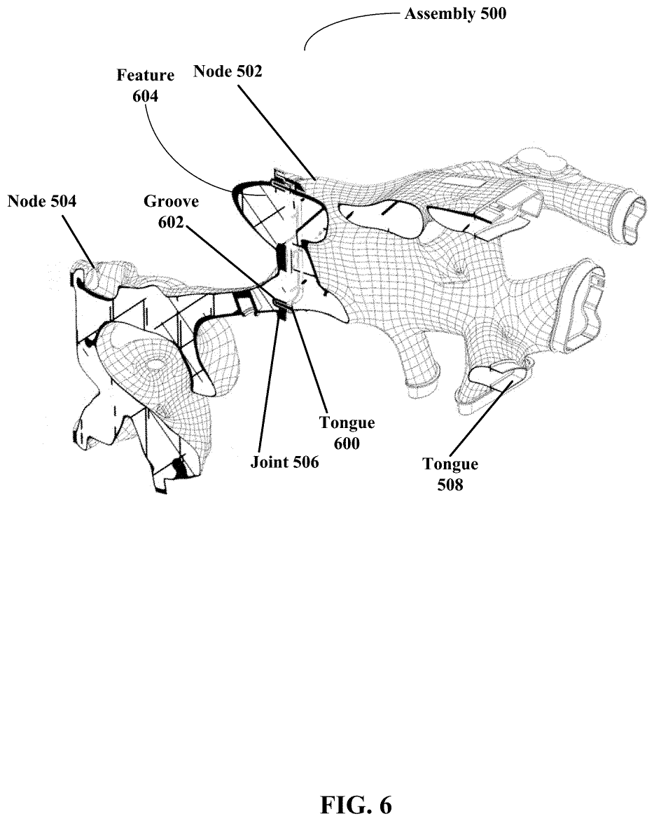

FIG. 6 illustrates a cross-sectional view of an assembly in accordance with an aspect of the present disclosure.

As shown in FIG. 6, joint 506 may include a tongue 600 from one node, in this example node 502, and a groove 602 in another node, in this example node 504.

Tongue 600 and groove 602 may allow for alignment and/or coupling of node 502 to node 504. Further, a given node may have both tongues 600 and grooves 602 to make the manufacturing process and/or assembly process of assembly 500 easier and/or more efficient.

In an aspect of the present disclosure, nodes 502 and 504 may be manufactured using additive manufacturing techniques, using one or more of the alloys described herein. Additive manufacturing of nodes 502 and/or 504 may allow nodes 502 and/or 504 to incorporate one or more features 604 that may be prohibitively expensive or very difficult to manufacture using other manufacturing techniques.

In an aspect of the present disclosure, feature 604 may provide strength, stiffening, directional compression and/or expansion of a given node. Feature 604 may be made of a different alloy than that of the node that feature 604 is part of, such that the overall assembly may be less expensive to produce, less expensive for the materials cost, more efficient to produce, etc. Feature 604 may extend inward towards an interior of a node 502/504, may be an exterior feature of a node 502/504, or may be an interior and exterior feature of a node 502/504. Further, feature 604 may extend through the thickness of a given node 502/504 without departing from the scope of the present disclosure. In some embodiments, feature 604 may additionally be self-supporting, i.e., printed without support structures during the additive manufacturing process.

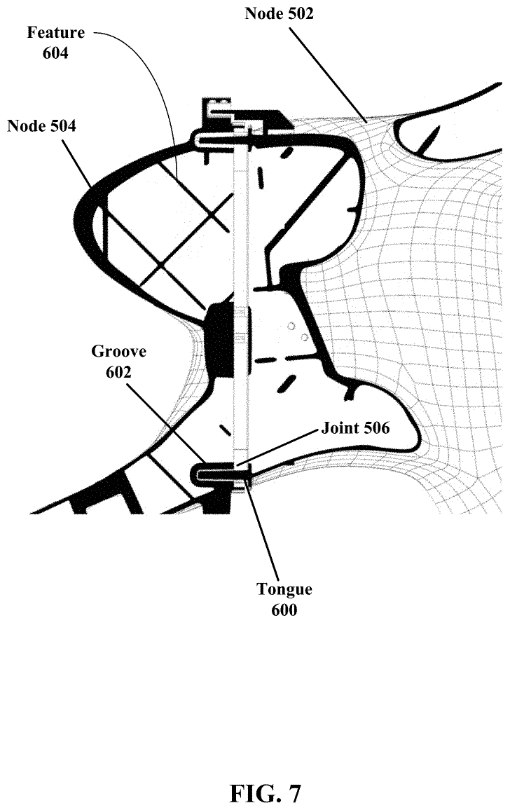

FIG. 7 illustrates a joint feature of an assembly in accordance with an aspect of the present disclosure.

As shown in FIG. 7, tongue 600 is coupled to groove 602 at joint 506. In an aspect of the present disclosure, tongue 600 may be made from a different alloy than that of node 502. In an aspect of the present disclosure, groove 602 may be made from a different alloy than that of node 504. In an aspect of the present disclosure, tongue 600 may be designed to have a gap between tongue 602 and groove 604 when node 502 is coupled to node 504, such that an adhesive or other material may be placed in between tongue 600 and groove 602. The material used may be a structural adhesive, and may have similar structural properties to the alloys used to create node 502, node 504, tongue 600, and/or groove 602. The material may also be a curable adhesive, such as an ultraviolet (UV) curable adhesive.

In an aspect of the present disclosure, feature 604 may be an “egg crate” feature, which is a self-supporting (i.e., does not require support structure when 3D printed) feature that is interior to a hollow structure such as a vehicle structure, that may act as a stiffening member, structural component, or directional strength portion of a given node. For example, and not by way of limitation, feature 604 may be oriented on node 504 such that node 504 will compress in a given direction and/or fashion, and resist compression in another direction and/or fashion. Such features 604 may be advantageous in vehicle design, such that a given node will compress in a known direction and resist compression in other directions during a vehicle crash, to protect occupants of the vehicle. Feature 604 may also provide aerodynamic flow, either internal to a node and/or external to a node, as well as provide other characteristics for a given node, without departing from the scope of the present disclosure.

The previous description is provided to enable any person skilled in the art to practice the various aspects described herein. Various modifications to these exemplary embodiments presented throughout this disclosure will be readily apparent to those skilled in the art, and the concepts disclosed herein may be applied in other ways than the examples disclosed herein. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

1. An alloy, comprising:
aluminum (Al);
magnesium (Mg); and
titanium (Ti); wherein the alloy has an elastic modulus of at least 68 gigapascals (GPa).

2. The alloy of claim 1, wherein the alloy has a melting point of at least 195 degrees Celsius (° C.).

3. The alloy of claim 2, wherein the alloy is exposed to an operating temperature that is greater than 30 percent (%) of the melting point of the alloy.

4. The alloy of claim 1, wherein an amount of the Mg in the alloy is less than or equal to about 18 percent (%) by weight of the alloy.

5. The alloy of claim 1, wherein an amount of the Ti in the alloy is less than or equal to about 15% by weight of the alloy.

6. The alloy of claim 1, further comprising at least one solute.

7. The alloy of claim 6, wherein the at least one solute is one or more of beryllium (Be), chromium (Cr), molybdenum (Mo), ruthenium (Ru), manganese (Mn), silicon (Si), cerium (Ce), yttrium (Y), and zirconium (Zr).

8. The alloy of claim 7, wherein the at least one solute is one or more of Be, Cr, Mo, Ru, and Mn, and an amount of the at least one solute in the alloy is less than or equal to about 50 percent (%) by weight of the alloy.

9. The alloy of claim 7, wherein the at least one solute includes Be in a proportion of less than or equal to about 12 percent (%) by weight of the alloy, and the at least one solute further includes one or more of Si, Ce, and Zr in a total proportion of less than or equal to about 12 percent (%) by weight of the alloy.

10. The alloy of claim 7, wherein the at least one solute further includes Be in a proportion of less than or equal to about 12 percent (%) by weight of the alloy, Cr in a proportion of between 10 and 25% by weight of the alloy, Mn in a proportion of less than or equal to about 15% by weight of the alloy, and one or more of Mo and Ru in a total proportion of less than or equal to about 20% by weight of the alloy.

11. The alloy of claim 12, wherein the at least one solute includes Ce in a proportion of less than or equal to about 25 percent (%) by weight of the alloy, the at least one solute includes Ru in a proportion of less than or equal to about 40 percent (%) by weight of the alloy, and the at least one solute further includes one or more of Si, Ce, and Zr in a total proportion of less than or equal to about 15 percent (%) by weight of the alloy.

12. The alloy of claim 7, wherein the at least one solute is one or more of Si, Ce, Y, and Zr, and an amount of the at least one solute is less than or equal to about 50 percent (%) by weight of the alloy.

13. The alloy of claim 12, wherein the at least one solute includes Y in a proportion of less than or equal to 3 percent (%) by weight of the alloy, and the at least one solute further includes one or more of Si, Ce, and Zr in a total proportion of less than or equal to about 3 percent (%) by weight of the alloy.

14. The alloy of claim 1,
wherein the elastic modulus is at least 100 gigapascals (GPa).

15. The alloy of claim 14, wherein the alloy has a melting point of at least 575 degrees Celsius (° C.).

16. The alloy of claim 15, wherein the alloy is exposed to an operating temperature that is greater than 30 percent (%) of the melting point of the alloy.

17. The alloy of claim 16, wherein an amount of the Mg in the alloy is less than or equal to 10% by weight of the alloy.

18. The alloy of claim 14, further comprising at least one solute.

19. The alloy of claim 18, wherein the at least one solute is one or more of beryllium (Be), chromium (Cr), molybdenum (Mo), ruthenium (Ru), manganese (Mn), silicon (Si), cerium (Ce), yttrium (Y), and zirconium (Zr).

20. The alloy of claim 19, wherein the at least one solute includes Be in a proportion of less than or equal to about 5 percent (%) by weight of the alloy, and the at least one solute further includes one or more of Si, Ce, and Zr in a total proportion of less than or equal to about 5 percent (%) by weight of the alloy.

21. The alloy of claim 19, wherein the at least one solute includes Be in a proportion of less than or equal to about 5 percent (%) by weight of the alloy, Cr in a proportion of between 20 and 50% by weight of the alloy, Mn in a proportion of between about 3 and 20% by weight of the alloy, and one or more of Mo and Ru in a total proportion of between about 3 and 20% by weight of the alloy.

22. The alloy of claim 19, wherein the at least one solute includes Cr in a proportion of between about 20 and 50 percent (%) by weight of the alloy, Ru in a proportion of less than or equal to about 10% by weight of the alloy, and the at least one solute further includes one or more of Si, Ce, and Zr in a total proportion of less than or equal to about 5 percent (%) by weight of the alloy.

23. The alloy of claim 19, wherein the at least one solute includes Yin a proportion of between about 20 and 50 percent (%) by weight of the alloy, and the at least one solute further includes one or more of Si, Ce, and Zr in a total proportion of between about 4 and 5% by weight of the alloy.
